(19) United States
(12) Patent Application Publication
(10) Pub. No.: US 2021/0387354 A1
(43) Pub. Date: Dec. 16, 2021

(54) AUTOMATIC WORKPIECE CARRYING MACHINE

(71) Applicant: FUJI CORPORATION, Chiryu (JP)

(72) Inventors: Akihiro OTA, Nagakute-shi (JP); Takafumi HARAGUCHI, Toyota-shi (JP)

(73) Assignee: FUJI CORPORATION, Chiryu (JP)

(21) Appl. No.: 17/285,298

(22) PCT Filed: Nov. 1, 2018
(86) PCT No.: PCT/JP2018/040664

§ 371 Date: Apr. 14, 2021

(51) Int. Cl. B25J 13/08; B25J 9/16

(52) U.S. Cl. CPC B25J 13/085; B25J 13/088; B25J 9/1679; B25J 9/1633

(57) ABSTRACT

An automatic workpiece conveyance machine configured to perform centering without the addition of new mechanical structures, comprising: a workpiece gripping device configured to grip a workpiece between the workpiece gripping device and a receiving chuck of a work machine; a workpiece delivery device having a moving mechanism for moving the workpiece gripping device on a centering plane orthogonal to the center axis of the receiving chuck; and a control device, configured to control the driving of the receiving chuck and the workpiece gripping device, and configured to identify the centering position based on torque generated in a positioning motor constituting the workpiece delivery device with one of the receiving chuck and the workpiece gripping device, gripping the workpiece, while the other one gripping and releasing the workpiece.

### TECHNICAL FIELD

The present disclosure relates to an automatic workpiece conveyance machine for aligning a workpiece with a partner device configured to deliver a workpiece.

### BACKGROUND ART

In a processing machine line or the like in which multiple machine tools are lined up, a workpiece is conveyed to each machine tool by an automatic workpiece conveyance machine. In the workpiece automatic conveyance machine, for example, a workpiece conveyance robot loaded on a traveling device moves between machines, stops in front of a relevant machine tool, and then delivers a workpiece to a main spindle chuck. In order to accurately deliver a workpiece with the workpiece conveyance robot, teaching along with the centering is required for the workpiece conveyance robot with respect to the main spindle chuck as the partner device. Conventionally, centering in an automatic workpiece conveyance machine is positioned on a main spindle chuck while a gripping device of the workpiece conveyance robot grips the workpiece, and the gripping device grips and releases the workpiece. In this case, a jog operation for slightly moving the position of the gripping device is performed, and the centering adjustment is performed by an operator assessing the sound or vibration when the gripping device grips the workpiece.

Patent Document 1 discloses an articulated robot configured to perform centering via an incorporated floating unit. Since a floating mechanism is provided with respect to the chuck, the chuck can be displaced such as to approach the center position of the workpiece even if the center is misaligned when the workpiece is gripped. Due to this, the articulated robot of the conventional example creates a state in which the workpiece is gripped in a no-load state. Then, by adding a deviation amount when the workpiece is gripped to the jog movement amount, a real chuck position in the robot coordinate system is obtained.

### PATENT LITERATURE

Patent Literature 1: Japanese Laid-open Patent Publication No. 7-75986

### BRIEF SUMMARY

### Technical Problem

The conventional centering method, in which an operator assesses the sound or the vibration when the gripping device grips the workpiece, was disadvantageous due to the lengthening of time to complete the centering operation in case of having an operator with little experience, for whom performing the adjustment operation is difficult. On the other hand, in an articulated robot in which the floating mechanism is incorporated, it is possible to complete the centering operation in a short time since the workpiece clamping position is obtained by a calculation process. However, the articulated robot provided with the floating mechanism has a complicated structure, which leads to problems such as an increase in size and cost. Further, since the workpiece conveyance robot increases in size, the processing machine line also increases in size.

It is therefore an object of the present disclosure to solve the above-mentioned problem by providing an automatic workpiece conveyance machine configured to perform centering without adding any new mechanical structures.

### Solution to Problem

The automatic workpiece conveyance machine of one aspect of the present disclosure comprises: a workpiece gripping device configured to grip a workpiece between the workpiece gripping device and a receiving chuck of a work machine; a workpiece delivery device having a moving mechanism configured to move the workpiece gripping device on a centering plane orthogonal to the center axis of the receiving chuck; and a control device, configured to control the driving of the receiving chuck and the workpiece gripping device, and configured to identify the centering position based on torque generated in a positioning motor constituting the workpiece delivery device with one of the receiving chuck and the workpiece gripping device, gripping the workpiece, while the other one gripping and releasing the workpiece.

### Advantageous Effects

With the above configuration, in a case where centering is not accomplished by one of the receiving side chuck and the workpiece gripping device, gripping the workpiece, while the other one gripping and releasing the workpiece, since torque is generated in the positioning motors of the workpiece delivery device when the workpiece is gripped, centering can be performed without adding any new mechanical structures by identifying the centering position based on the torque.

### BRIEF DESCRIPTION OF DRAWINGS

FIG. 1 A perspective view showing a portion of a processing machine line.

FIG. 2 A side view of an articulated robot in a folded, movable state.

FIG. 3 A perspective view of the articulated robot extended in a workpiece delivering state.

FIG. 4 A partial cross-sectional view of the articulated robot shown in FIG. 2 as viewed in the direction of arrows A-A.

FIG. 5 A partial cross-sectional view of the articulated robot shown in FIG. 2 as viewed in the direction of arrows B-B.

FIG. 6 A block diagram showing a simplified control system of the automatic workpiece conveyance machine.

FIG. 7 A diagram showing a delivery at the time of centering in the automatic workpiece conveyance machine with respect to a machine tool.

FIG. 8 A diagram showing a method for identifying a centering position.

### DESCRIPTION OF EMBODIMENTS

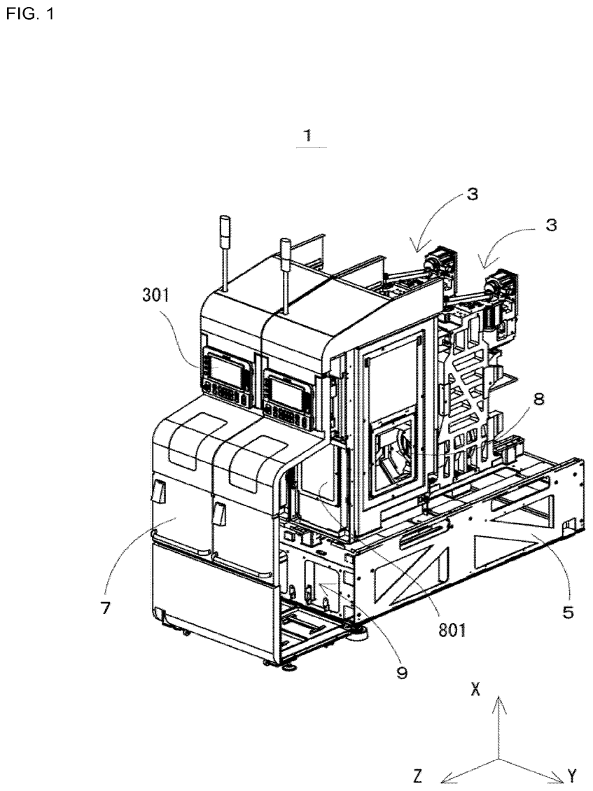

Next, an embodiment of the automatic workpiece conveyance machine of the present disclosure will be described below with reference to the drawings. In the present embodiment, an automatic workpiece conveyance machine incorporated in a processing machine line will be described as an example. FIG. 1 is a perspective view showing a portion of a processing line. In processing machine line 1 of the present embodiment, multiple work machines, such as machine tools, are lined up, and all processes are performed on a workpiece. In particular, in the present embodiment, machine tools and the like are modularized, and multiple processing modules 3 are loaded on base 5 next to each other as shown in FIG. 1.

In processing machine line 1, two processing modules 3 are loaded on one base 5, and the number of bases 5 and predetermined processing modules 3 can be increased or decreased to any extent depending on the content to be processed. In processing machine line 1, processing modules 3 are all configured by an outer cover having the same shape so that the appearance is unified throughout the line. Front covers 7 of the outer covers serving as the front face of the line are shown in the drawing, and processing machine line 1 is formed with front covers 7 so as to form conveyance space 9 extending in the direction of the line. In the present embodiment, the machine body width direction of processing module 3 is assumed to be the Y-axis direction, the machine body front-rear direction is assumed to be the Z-axis direction, and the machine body up-down direction is assumed to be the X-axis direction.

In processing module 3, a movable bed is loaded on rails on base 5, and a processing machine main body such as a lathe or a machining center is assembled to the movable bed. Accordingly, processing module 3 shown in FIG. 1 is disposed at the time of processing, but can be moved in the front-rear direction (the Z-axis direction) during maintenance or component exchanging. Processing module 3 shown in FIG. 1 is a machine tool and is configured with processing space 8 for performing processing on a workpiece gripped by a spindle chuck. Specifically, a rotary tool such as an end mill or a cutting tool such as a tool held by a tool base moves with respect to a workpiece gripped by the spindle chuck and rotated so that predetermined processing is performed.

Since chips and coolant scatter during processing of the workpiece, processing space 8 is configured as a closed space. Therefore, an opening portion is formed on the machine body front side of processing space 8 so that workpieces can be delivered to and from the spindle chuck by the automatic workpiece conveyance machine within conveyance space 9, and automatic opening/closing door 801 configured to slide up and down is provided there. Processing is performed in processing space 8 in a state in which automatic opening/closing door 801 is closed, and when automatic opening/closing door 801 is opened, the conveyance robot enters processing space 8 to deliver the workpiece.

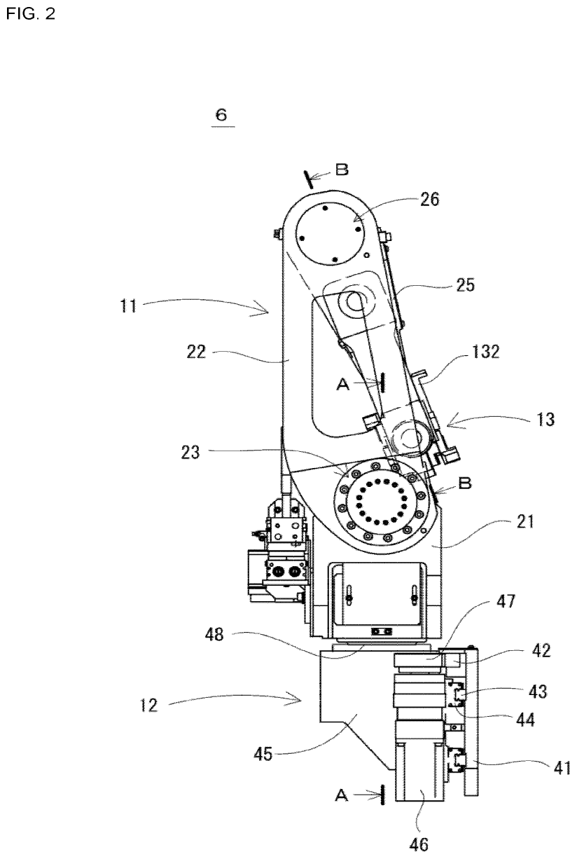

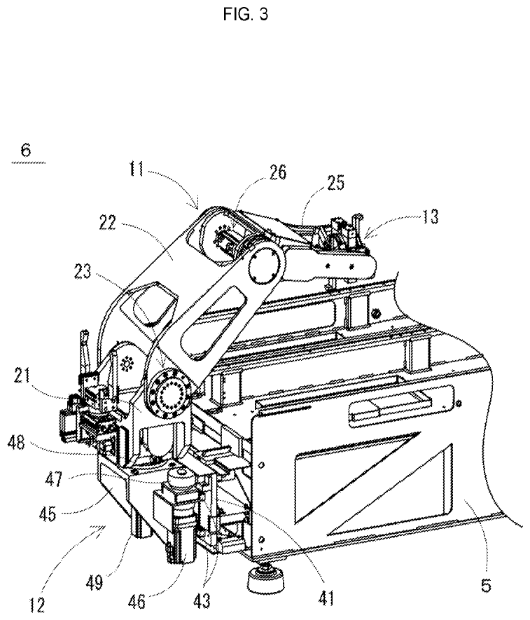

FIG. 2 and FIG. 3 are views showing the automatic workpiece conveyance machine of the present embodiment, where FIG. 2 is a side view of the articulated robot in a folded, movable state and FIG. 3 is a perspective view of the articulated robot extended in a workpiece delivering state. Automatic workpiece conveyance machine 6 has articulated robot 11 for delivering workpieces to and from a spindle chuck or the like, and traveling device 12 is provided for moving articulated robot 11 loaded on traveling base 45 in the Y-axis direction in conveyance space 9.

Articulated robot 11 is assembled on traveling base 45 via rotary table 48. Support base 21 is fixed on rotary table 48, upper arm member 22 is connected to support base 21 via first joint mechanism 23, and front arm member 25 is further connected to upper arm member 22 via second joint mechanism 26. Robot hand 13 for gripping and replacing a workpiece is attached to the end of front arm member 25 serving as the distal end of articulated robot 11.

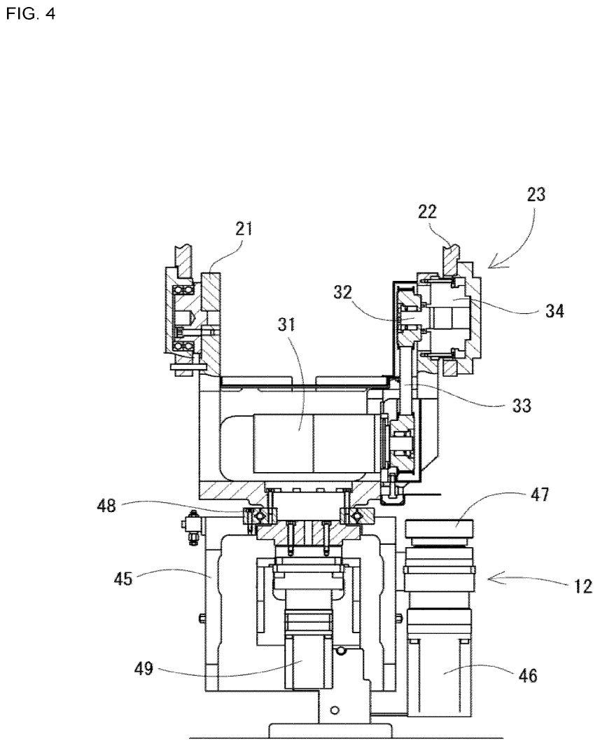

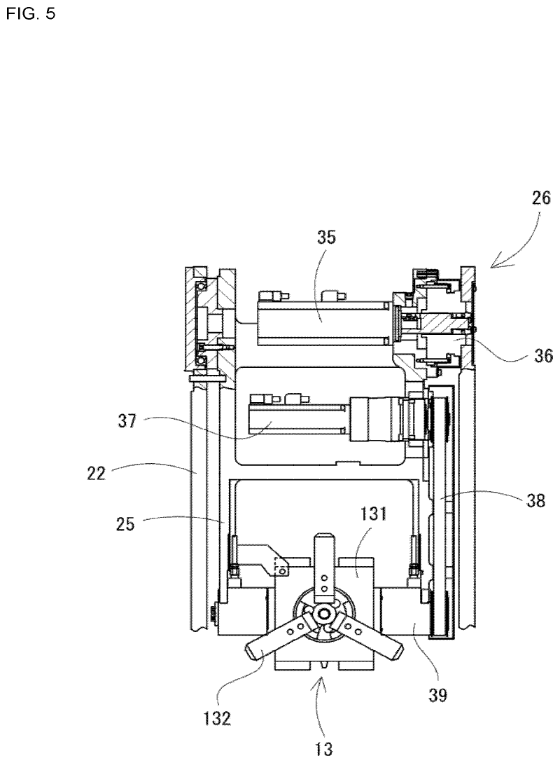

Articulated robot 11 is configured such that the angle of each of upper arm member 22, front arm member 25, and robot hand 13 are adjusted to change orientation of articulated robot 11 to the operating orientation shown in FIG. 3 or the traveling orientation shown in FIG. 2. Here, FIG. 4 and FIG. 5 are diagrams showing the drive mechanisms of articulated robot 11 and robot hand 13, where FIG. 4 shows a partial cross-sectional view of articulated robot 11 shown in FIG. 2 taken along line A-A, and FIG. 5 is a partial cross-sectional view of articulated robot 11 shown in FIG. 2 taken along line B-B.

First, as shown in FIG. 4, in first joint mechanism 23, first joint motor 31 is fixed to support base 21, and timing belt 33 is stretched between a pulley on the rotational axis of first joint motor 31 and a pulley on shaft 32. Upper arm member 22 is pivotally supported by a pair of left and right support portions with respect to support base 21 but is configured to transmit the power of first joint motor 31 to one shaft 32 via deceleration device 34 to adjust the angle of upper arm member 22 with respect to support base 21.

As shown in FIG. 5, in second joint mechanism 26, second joint motor 35 is fixed to front arm member 25, and the rotary shaft thereof is coupled to deceleration device 36. Articulated robot 11 is formed such that front arm member 25 fits inside upper arm member 22 and is pivotally attached at two positions in the width direction. Deceleration device 36 is provided on one side thereof and is configured to adjust the angle of front arm member 25 with respect to upper arm member 22 by driving of second joint motor 35.

Next, robot hand 13 is attached to the distal end of front arm member 25 via bearing member 39. Timing belt 38 is passed between bearing member 39 and the rotary shaft of hand motor 37 via a pulley so that the angle of robot hand 13 is adjusted by the driving of hand motor 37. In robot hand 13, a chuck mechanism having chuck claws 132 is formed on both front and rear faces of main body block 131. The chuck mechanism is configured with three chuck claws 132 arranged at equal intervals in the circumferential direction and slides in synchronization in the radial direction by hydraulic pressure.

Articulated robot 11 is incorporated in conveyance space 9 of processing machine line 1 and, via traveling device 12, moves so as to face predetermined processing module 3. As shown in FIG. 2 and FIG. 3, support plate 41 of traveling device 12 is fixed to the front face of base 5, and rack 42 and two rails 43 are attached to base 5 in the horizontal direction. Traveling base 45 is assembled such that traveling slide 44, formed integrally with traveling base 45, grips and slides along rails 43. Traveling motor 46 is fixed to traveling base 45, and pinion 47 fixed to a rotary shaft of traveling motor 46 engages with rack 42. Accordingly, pinion 47 rolls along rack 42 by the driving of traveling motor 46 so that traveling base 45 moves in the Y-axis direction along rails 43.

Pivoting motor 49 is fixed in the vertical direction to the inner side of traveling base 45, and rotary table 48 is coupled to a rotary shaft of pivoting motor 49. Articulated robot 11 is assembled on rotary table 48, and the workpiece delivery operation and the like are performed by controlling the orientation of upper arm member 22, front arm member 25, and robot hand 13. In these cases, in order to accurately deliver the workpiece to and from a machine tool, centering is performed with the spindle chuck or the like, and teaching based on the centering is performed. However, since, conventionally, centering has been assessed by an operator based on the sound or vibration generated when the gripping device grips the workpiece as described above, much experience is required to perform centering in a short time.

In this regard, automatic workpiece conveyance machine 6 of the present embodiment is configured to identify the centering position based on the torque values from positioning motors. The positioning motors of automatic workpiece conveyance machine 6 used for centering correspond to first joint motor 31, second joint motor 35, hand motor 37 of articulated robot 11, and traveling motor 46 and pivoting motor 49 of traveling device 12, all of which are servo motors. However, in the present embodiment, in order to simplify the calculation process, the centering position is identified based on the torque values of only second joint motor 35 and traveling motor 46.

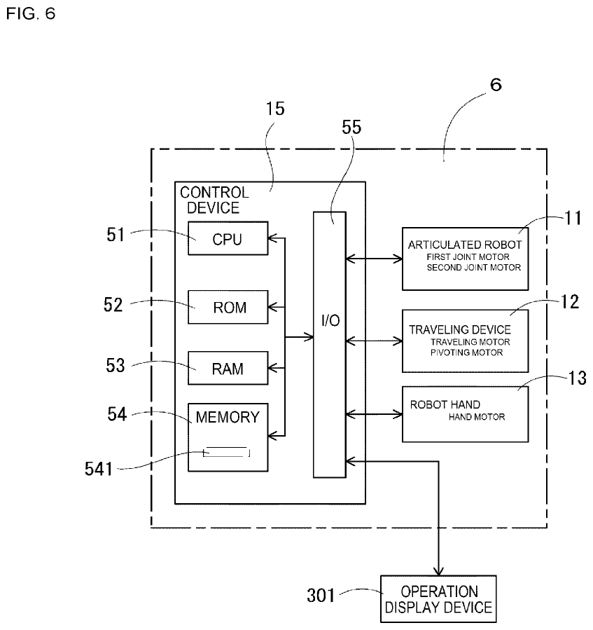

FIG. 6 is a block diagram showing a simplified control system of automatic workpiece conveyance machine 6. Control device 15 mainly consists of a computer having a storage device such as ROM 52, RAM 53, and non-volatile memory 54 in addition to CPU 51, and is connected to articulated robot 11, traveling device 12, the positioning motor of robot hand 13, and the like via I/O 55. Control device 15 stores in memory, for example, the conveyance route for workpieces to be conveyed to processing modules 3 and a conveyance program for controlling the delivering orientation or the like of articulated robot 11. In particular, in the present embodiment, centering program 541 for centering the main spindle chuck and the like is stored.

In processing machine line 1, a control device is also loaded on each processing module 3, and although not shown in detail, a LAN is configured so that such a control device on the work machine side and control device 15 of automatic workpiece conveyance machine 6 are connected via a line concentrator. As shown in FIG. 1, processing module 3 is provided with operation display device 301 configured to display work information, an operation screen, and the like, receive settings and the like inputted by an operator, and is connected to each control device by a LAN. As a result, in addition to operation instructions to automatic workpiece conveyance machine 6, measurement results can be displayed from operation display device 301.

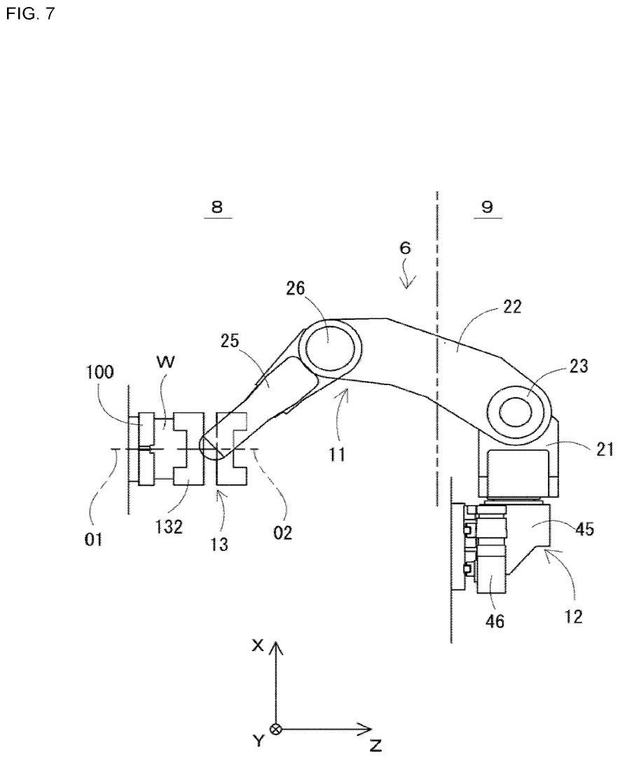

FIG. 7 is a diagram showing a delivery at the time of centering in automatic workpiece conveyance machine 6 with respect to a machine tool. Automatic workpiece conveyance machine 6 is driven and controlled in accordance with centering program 541 of control device 15. First, articulated robot 11 loaded on traveling base 45 moves inside conveyance space 9 in the upright orientation shown in FIG. 2 by the driving of traveling motor 46 and stops at the front face of processing module 3. Then, as shown in FIG. 3 and FIG. 7, articulated robot 11 is transformed into an extended state and enters processing space 8 in which automatic opening/closing door 801 is opened. The orientation of articulated robot 11 is transformed by the driving of first joint motor 31 and second joint motor 35, and the angle of robot hand 13 with respect to spindle chuck 100 holding workpiece W is adjusted by the driving of hand motor 37.

Robot hand 13 at the time of delivery is required to have center axis O2 of three chuck claws 132 coinciding with center axis O1 of main spindle chuck 100 when robot hand 13 is disposed at the position for gripping workpiece W of main spindle chuck 100. In this case, center axes O1 and O2 are parallel to each other in the Z-axis direction. Thus, in centering program 541, centering control for adjusting the positional deviation of center axes O1 and O2 on the XY-plane coordinate system (centering plane) of automatic workpiece conveyance machine 6 is performed. Prior to centering control, the operator causes main spindle chuck 100 to grip workpiece W and prepares to position robot hand 13 at a position where workpiece W is to be gripped by manual operating articulated robot 11 or traveling device 12. However, a part of this preparation operation may also be automatically performed.

After the preparation operation is performed, the operator presses the centering function button of operation display device 301 to initiate centering. In the centering, the gripping and releasing of workpiece W is performed by robot hand 13. At this time, when a positional deviation occurs in the center axes O1 and O2, robot hand 13 is displaced by the deviation amount in accordance with the gripping operation of chuck claws 132 uniformly gripping workpiece W. Then, when robot hand 13 is displaced by being pulled in a predetermined direction, torque is generated in first joint motor 31 of articulated robot 11, traveling motor 46 of traveling device 12, or the like.

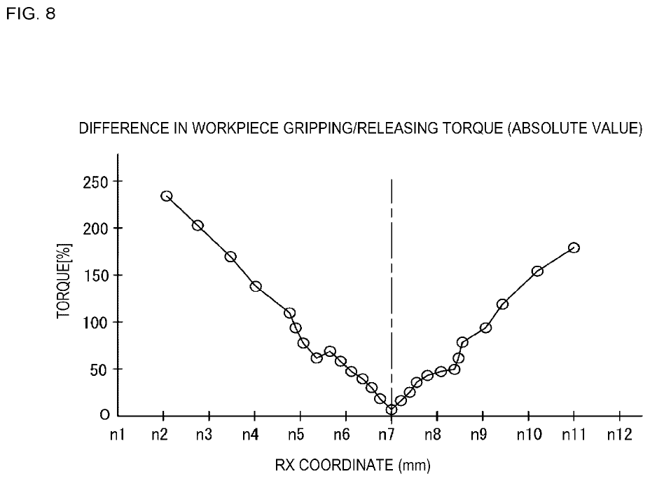

Since the motor current and torque of a positioning motor such as first joint motor 31 are statically in a proportional relationship, the torque can be measured by current-voltage conversion of the motor current. In the present embodiment, centering for aligning center axes O1 and O2 in the XY plane coordinate system is performed based on the torque value of second joint motor 35 in the X-axis direction and the torque value of traveling motor 46 in the Y-axis direction. Here, FIG. 8 shows a method for identifying the centering position. In particular, a case in which the centering position in the X-axis direction is identified is shown.

In the present embodiment, the absolute value of the difference between the torque value when chuck claws 132 grip workpiece W and the torque value when workpiece W is released is determined. In a state in which robot hand 13 has released workpiece W, the torque for supporting the weight of articulated robot 11 or robot hand 13, in other words, its own weight is generated with respect to the positioning motor, that is, second joint motor 35. On the other hand, when the positions of center axes O1 and O2 are misaligned, since robot hand 13 is pulled by the deviation amount, the torque is generated in second joint motor 35 in which this tension load is added to the torque from the weight of articulated robot 11 or robot hand 13.

If the deviation amount of center axes O1 and O2 is large, the tension load is increased, and a larger torque is generated in second joint motor 35. Then, as the positions of center axes O1 and O2 approach each other, the torque corresponding to the tension load generated in second joint motor 35 decreases, and the difference in torque value between the case where workpiece W is gripped and the case where workpiece W is released decreases as shown in FIG. 8. Thus, in centering control, the position of robot hand 13 is displaced by a constant amount in the X-axis direction by driving articulated robot 1. The gripping and releasing of workpiece W are repeated at each position, and each time, the absolute value of the difference in the value of the torque generated in second joint motor 35 is calculated as a detection value. As a result, as shown in FIG. 8, the position at which the detection value is minimized can be identified, and the position becomes the centering position in the X-axis direction in the XY plane coordinate system (centering plane).

Next, assuming that the position in the X-axis direction in the XY plane coordinate system is n7, the position of robot hand 13 in the Y-axis direction is displaced by a constant amount by the driving of driving motor 46. Similarly in the Y-axis direction, the gripping and releasing of workpiece W are repeated at each position, and the absolute value of the difference in the value of the torque generated in driving motor 46 is calculated as a detection value each time. As a result, even in the case of the Y-axis direction, a change in the torque value corresponding to the position of robot hand 13 as shown in FIG. 8 is obtained. Therefore, the position at which the detection value is minimized can be specified, and the position becomes the centering position in the Y-axis direction of the XY plane coordinate system.

Therefore, with the present embodiment, since the centering position can be automatically identified in the XY plane coordinate system by the centering control, even if the operator is not a skilled worker, as has been the case up to now, it is possible to deliver workpiece W to and from processing module 3 by automatic workpiece conveyance machine 6 that has performed proper centering. In addition, since the automatic centering is performed in a short time by centering control, it is possible to eliminate operations that are troublesome for the operator and shorten the time until processing is started. In addition, since automatic workpiece conveyance machine 6 performs centering by measuring the torque of the positioning motor with an existing structure as is and no improvements are necessary, it is possible to achieve the above-mentioned effect while suppressing costs.

In the centering control, although the centering position is identified based on the torque value of second joint motor 35 with respect to the X-axis direction, the tension load acting in response to gripping the workpiece also generates torque in first joint motor 31 and hand motor 37. The tendency of the torques generated by motors 31, 32, 37 is the same. The reason why second joint motor 35 is selected among them is that the difference in torque value is clear. This also applies to why driving motor 46 is selected for the Y-axis direction. As a result, by selecting the target positioning motor in the X-axis direction and the Y-axis direction in this manner, the burden of the calculation process in control device 15 can be reduced, thus reducing the processing time. However, the difference may be calculated by measuring the torques of all the positioning motors, and the centering position may be identified, for example, from the average value thereof.

Although an embodiment of the present disclosure has been described above, the present disclosure is not limited to the embodiment, and various modifications can be made within a scope which does not depart from the gist of the present disclosure. For example, although articulated robot 11 is exemplified as a workpiece delivery device in the above embodiment, a gantry loader or the like can also be used as an automatic workpiece conveyance machine. For example, in the above embodiment, workpiece W is gripped by spindle chuck 100 in order to repeatedly displace the position of robot hand 13 for torque measurement at the time of centering, but workpiece W may be gripped by robot hand 13 so that spindle chuck 10 repeats the gripping and releasing of workpiece W.

### REFERENCE SIGNS LIST

1 . . . Processing machine line 3 . . . Processing module 6 . . . Automatic workpiece conveyance machine 8 . . . Processing space 9 . . . Conveyance space 11 . . . Articulated robot 12 . . . Traveling device 13 . . . Robot hand 15 . . . Control device 22 . . . Upper arm member 23 . . . First joint mechanism 25 . . . Front arm member 26 . . . Upper arm member 31 . . . First joint motor 35 . . . Second joint motor 37 . . . Hand motor 45 . . . Traveling base 46 . . . Traveling motor 49 . . . Pivoting motor 132 . . . Chuck 301 . . . Operation display device 541 . . . Centering program

1. An automatic workpiece conveyance machine, comprising:
a workpiece gripping device configured to grip a workpiece between the workpiece gripping device and a receiving chuck of a work machine;
a workpiece delivery device having a moving mechanism for moving the workpiece gripping device on a centering plane orthogonal to the center axis of the receiving chuck; and
a control device, configured to control the driving of the receiving chuck and the workpiece gripping device, and configured to identify the centering position based on torque generated in a positioning motor, constituting the workpiece delivery device, with one of the receiving chuck and the workpiece gripping device, gripping the workpiece, while the other one gripping and releasing the workpiece.

2. The automatic workpiece conveyance machine of claim 1, wherein the control device identifies the centering position based on torque generated in a positioning motor constituting the workpiece delivery device by way of the workpiece gripping device gripping and releasing the workpiece gripped by the receiving chuck.

3. The automatic workpiece conveyance machine of claim 1, wherein the control device adjusts the position of the workpiece gripping device on the centering plane and identifies, as the centering position, a position at which the difference in torque value of the positioning motor is reduced, the difference of which being caused when the workpiece is gripped and released by the receiving chuck or the workpiece gripping device.

4. The automatic workpiece conveyance machine of claim 1, wherein the workpiece delivery device has multiple positioning motors for moving the workpiece gripping device in the X-axis direction and the Y-axis direction, which are orthogonal to each other, on the centering plane, and the control device identifies the centering position in each direction based on the torque of each positioning motor in each direction.

5. The automatic workpiece conveyance machine of claim 1, wherein the workpiece delivery device comprises:
a traveling base configured to of move the workpiece gripping device in the horizontal direction on the centering plane by the positioning motor; and
an articulated robot, in which an upper arm member, coupled to the traveling base via a first joint mechanism, and a front arm member, to which the workpiece gripping device is assembled via a rotation mechanism, are coupled together via a second joint mechanism; the articulated robot being configured to move the workpiece gripping device in the up-down direction on the centering plane and the direction parallel to the center axis of the receiving chuck by way of the positioning motor of each of the first joint, the second joint, and the rotation mechanism.

6. The automatic workpiece conveyance machine of claim 5, wherein the control device identifies the centering position in the up-down direction in the centering plane based on torque generated in the positioning motor constituting the second joint mechanism of the articulated robot.
